(19) United States
(12) Patent Application Publication
(10) Pub. No.: US 2001/0028603 A1
(43) Pub. Date: Oct. 11, 2001

(54) Usage history registering apparatus and automatic database retrieval statement generating apparatus

(75) Inventor: Hideo Shimazu, Tokyo (JP)

Correspondence Address: David A. Blumenthal, FOLEY & LARDNER, Suite 500, 3000 K Street, N.W., Washington, DC, 20007-5109, US

(73) Assignee: NEC CORPORATION

(21) Appl. No.: 09/826,904

(22) Filed: Apr. 6, 2001

(30) Foreign Application Priority Data
Apr. 7, 2000 (JP) 111909/2000

(51) Int. Cl. G04B 47/00; G04F 8/00; G04F 10/00

(52) U.S. Cl. 368/10; 368/107; 707/500

(57) ABSTRACT

A usage history registering apparatus includes item value history storage sections, a total usage record count storage section, and an item value counting section. The item value history storage units are provided in one-to-once correspondence with the items of a table in a relational database, and hold item value history information for each of partial sets divided from value sets that can be taken as values of corresponding items, the item value history information consisting of a conditional statement set for each partial set to determine a specific partial set to which a given item value belongs and a cumulative count for each partial set. The total usage record count storage section holds the total number of history update records processed. The item value counting section receives a history update record, determines, for each item of the input record, a specific partial set in the item to which a corresponding item value belongs, according to the conditional statement in the item value history information corresponding to the item, increments by one the cumulative count corresponding to the partial set to which the item value belongs, and also increments the total usage record count by one. An automatic database retrieval statement generating apparatus is also disclosed.

### BACKGROUND OF THE INVENTION

The present invention relates to a technique of automatically generating a retrieval statement for a relational database and, more particularly, to a technique of automatically generating a retrieval statement for retrieving information useful for a user.

Currently, in the field of information retrieval, relational databases (RDBs) are widely used. In an RDB, a retrieval statement is generated by using SQL (Structured Query Language). According to SQL, a retrieval conditional statement is defined by using the clauses “SELECT- FROM -WHERE”. A general form of this statement is

SELECT item in table FROM table name WHERE retrieval condition

The meaning of this form is to retrieve a record that satisfies the condition written in the “WHERE” clause from the table designated by the “FROM” clause and return the value of the item designated by the “SELECT” keyword from the record.

For example, FIG. 1 shows an example of the table of a wine database. If the user issues, to a database management system, the following retrieval statement:

SELECT name price FROM wine database WHERE (price>3000) and (color=white)

then, the following values are returned:

Chablis: 4500 YEN

St.-Emilion: 3500 YEN

In this manner, conventional database retrieval systems are generally designed to execute a retrieval statement designated by a user and return the retrieval result.

When a user performs database retrieval by generating a retrieval statement, a large quantity of retrieval results may be returned in some cases, and no retrieval result may be returned because of the absence of any records that satisfy the condition in other cases. If the user is not accustomed to using the database, he/she may be confused about how to generate an SQL statement to acquire a proper quantity of retrieval results. Japanese Patent Laid-Open No. 6-68153 “Database Similar Item Retrieval Method” (reference 1) has already proposed a technique used in such a case. According to this technique, the condition description portion (“WHERE” portion) of the SQL statement designated by the user is analyzed to automatically generate a similar condition so as to generate and issue another SQL statement. Assume that this technique is used. If, for example, the user cannot acquire any retrieval result by executing the following retrieval statement for the database in FIG. 1:

“German white wine at 700 yen or less”

then, a similar retrieval statement like “German white wine at 1000 yen or less” or “European white wine at 700 yen or less” is generated, and retrieval results can be presented.

According to this technique, however, the user himself/herself must generate an original retrieval statement as a seed in the first place. The technique cannot be used without any original retrieval statement as a seed. In many cases, however, some recommended information must be presented to users even in the absence of any original retrieval statements. For example, when a person enters a tailor shop, a salesperson selects and recommends some clothes. When a customer asks a sommelier to select an appropriate wine, he/she recommends some wine. These behaviors are equivalent to retrieve information without any original retrieval statement by a user.

A technique of providing some recommended information for the user even without any original retrieval statement as a seed is disclosed in Japanese Patent Laid-Open No. 7-56929 (reference 2). This technique is a history-based database retrieval scheme in which when the user is to purchase a given article, registered articles having feature characteristics similar to those of articles that were purchased by the user are retrieved from an article database by using a history of purchases made by the user in the past, thereby presenting the retrieved articles as recommended articles. More specifically, this scheme includes an article database holding article data as purchase targets, a history database holding a history of articles purchased by the user in the past, a distance calculating section for calculating the degrees of similarity between the articles registered in the article database and the articles purchased by the user in the past, a similar article sorting section for sorting the articles registered in the article database in decreasing order of degree of similarity on the basis of the calculation result obtained by the distance calculating section, a recommended article display section for displaying similar articles as recommended articles on the basis of the result obtained by the similar article sorting section, and a history registering section for registering a history of articles actually purchased by the user in the history database.

Since this conventional technique uses a history retention scheme of registering the article data of every article purchased by the user in the past as one history data in the history database, a large-capacity storage unit is required to retain history data. In addition, in retrieving registered articles having characteristic features similar to those of article purchased by the user in the past, since the degree of similarity must be calculated for each registered article, if the number of registered articles is large, a very large calculation amount is required to retrieve recommended article data.

### SUMMARY OF THE INVENTION

It is an object of the present invention to provide a usage history registering apparatus which can retain information about usage histories of an indefinite number of users or each user of a database with a relatively small storage capacity.

It is another object of the present invention to provide an automatic database retrieval statement generating apparatus which can obtain information useful to users with a relatively small calculation amount on the basis of usage histories of an indefinite number of users or each user of a database.

In order to achieve the above objects, according to the present invention, there is provided a usage history registering apparatus comprising item value history storage units which are provided in one-to-once correspondence with items of a table in a relational database in which a usage history is to be registered, and hold item value history information for each of partial sets divided from value sets that can be taken as values of corresponding items, the item value history information being constituted by a conditional statement set for each partial set to determine a specific partial set to which a given item value belongs and a cumulative count for each partial set, a total usage record count storage section for holding the total number of history update records processed, and an item value counting section for receiving a history update record, determining, for each item of the input record, a specific partial set in the item to which a corresponding item value belongs, according to the conditional statement in the item value history information corresponding to the item, incrementing by one the cumulative count corresponding to the partial set to which the item value belongs, and also incrementing the total usage record count by one.

### BRIEF DESCRIPTION OF THE DRAWINGS

FIG. 1 is a view for explaining the principle of the present invention;

FIG. 2 is a block diagram showing a database retrieval system according to the present invention;

FIG. 3 is a view showing an example of the arrangement of a storage unit according to the first embodiment of the present invention;

FIG. 4 is a block diagram showing an example of the arrangement of a history registering apparatus according to the first embodiment of the present invention;

FIG. 5 is a flow chart showing a procedure by which an item value calculating section of the history registering apparatus according to the first embodiment of the present invention updates an item value history storage section;

FIG. 6 is a view showing an example of the arrangement of an automatic retrieval statement generating apparatus according to the first embodiment of the present invention;

FIG. 7 is a flow chart showing an example of the processing performed by a valid item value selecting section in the history registering apparatus according to the first embodiment of the present invention;

FIG. 8 is a flow chart showing an example of the processing performed by a “retrieval statement with degree of preference” generating section in the history registering apparatus according to the first embodiment of the present invention;

FIG. 9 is a view showing an example of the arrangement of a storage unit according to the second embodiment of the present invention;

FIG. 10 is a block diagram showing an example of the arrangement of a history registering apparatus according to the second embodiment of the present invention;

FIG. 11 is a view showing an example of the arrangement of an automatic retrieval statement generating apparatus according to the second embodiment of the present invention;

FIG. 12 is a block diagram showing an example of the arrangement of an activation unit used in the third embodiment of the present invention;

FIG. 13 is a view showing an example of the arrangement of a storage unit according to the fourth embodiment of the present invention; and

FIG. 14 is a view showing an example of the arrangement of an automatic retrieval statement generating apparatus according to the fourth embodiment of the present invention.

### DESCRIPTION OF THE PREFERRED EMBODIMENTS

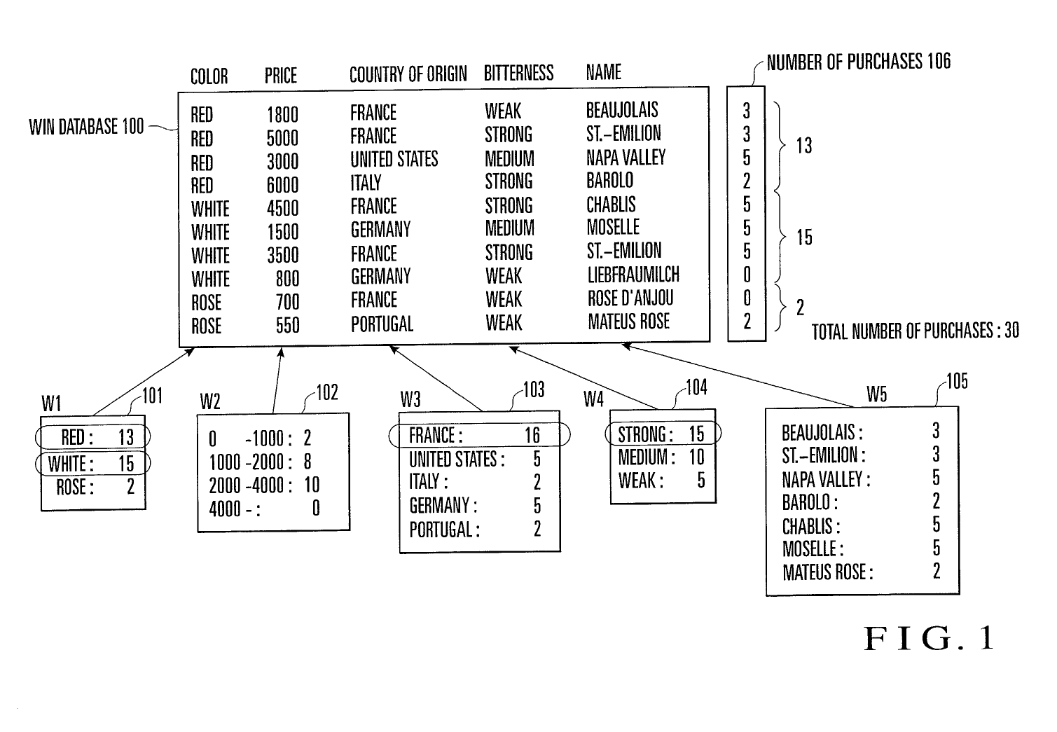

The present invention will be described in detail next with reference to the accompanying drawings. The principle of the present invention will be described first with reference to FIG. 1.

Consider a wine database 100. Ten types of wines are registered in this database. The numbers of times that the respective wines were purchased are recorded in a “purchase count” 106. The “purchase count” 106 indicates that 30 wines were purchased so far. For example, Beaujolais wine at the top of the list was purchased three times so far. In this case, the number of times of purchases is recorded. However, this may be replaced with the number of times that the user selected one of the records retrieved from the wine database 100 and presented to the user as an optimal retrieval result. Alternatively, the number of times that a given record was referred to from the wine database 100 may be recorded.

In item value history storage sections 101 to 105, the values that can be taken in the respective items of the wine database 100 and the numbers of times that the values in the items appeared in associated with the wines purchased in the past are recorded. For example, as the values in the “color” item, red, white, and rose exist. In the section 101, therefore, there are entry items (value entries) for the three values, i.e., red, white, and rose. With regard to the 30 wines purchased in the past, 13 red wines, 15 white wines, and 2 rose wines were purchased. Therefore, the total number of wines purchased is recorded. Data are written in the item value history storage sections 103, 104, and 105 in the same manner. In only the section 102, data are written in a slightly different manner. In the section 102, the values of the “price” item are not directly written like “1800 yen”, “5000 yen”, and “3000 yen”, but the ranges of prices are defined as value entries. That is, wines are defined like wines of less than 1000 yen, wines ranging between 1000 yen and 2000 yen, and the like, and the numbers of times that the respective value entries appear are counted by checking in which ranges purchased wines fall. Assume that all constituent elements in this embodiment are defined in the form used for the section 102. In the item value history storage sections 101, 103, 104, and 105 as well, conditional statements set in the respective value entries are written. For example, in the section 101, the conditional statements “color=red”, “color=white”, and “color=rose” are additionally written.

Every time a wine is retrieved from the wine database or purchased, information indicating which wine was selected or purchased as an optimal wine by the user is always recorded in the form of cumulative counts of the corresponding entry values in the item value history storage sections 101 to 105.

When an instruction to automatically generate a retrieval statement is provided, values of the past selected values in the respective items which were selected many times are selected and presented. The method for this operation is substantially executed in the following procedures.

Procedure 1:

The respective item value history storage sections 101 to 105 are checked to select only values that were selected a relatively large number of times in the past. As a value for defining “values that were selected a relatively large number of times”, a threshold is set in advance. In the case shown in FIG. 1, 35% is the threshold. That is, only values each occupying 35% or more of the total count (30) are selected to from a set of values. In the case of “color item, therefore, only the values of colors each exhibiting a track record of 10.5 or more purchases are selected. In this case, only “red” and “white” are selected. In all the item value history storage sections in FIG. 1, item values having such values are framed. In addition to “red” and “white” in the “color” item, only “France” in the “country of origin” item and “strong” in the “bitterness” item are selected. Finally, three value sets are formed from the respective item value history storage sections, i.e., color (red, white), country of origin (France), and bitterness (strong).

Procedure 2:

An arbitrary element is extracted from each of the sets in the item value history storage sections to form a combination in a round-robin manner, thereby forming all combinations. If there are three item value history storage section sets are present, and the respective sets respectively include L, M, and N elements, (L×M×N) combinations are formed. In this case, 2×1×1=2; the following two combinations are formed:

combination 1: (color: red, country of origin: France, bitterness: strong) (1)

combination 2: (color: white, country of origin: France, bitterness: strong) (2)

Procedure 3:

The likelihood of each combination is then calculated, which is referred to as the degree of preference in the present invention. The degree of preference is defined as follows:

degree of preference=value obtained by normalizing sum total of (weights for the respective item value history storage sections×ratios of occurrence counts to total count) (3)

Referring to FIG. 1, letting W1 be the weight of the “color” item, W3 be the weight of the “country of origin” item, and W4 be the weight of the “bitterness” item,

degree of preference of combination 1=(W1×13/30+W3×16/30+W4×15/30)/(W1+W3+W4) (4)

degree of preference of combination 2=(W1×15/30+W3×16/30+W4×15/30)/(W1+W3+W4) (5)

Procedure 4:

When combinations (1) and (2) are formed, they can be simply converted into SQL statements as follows:

SQL1: SELECT name FROM wine WHERE color=red AND country of origin=France AND bitterness=strong (6)

SQL2: SELECT name FROM wine WHERE color=white AND country of origin=France AND bitterness=strong (7)

If these SQL statements are directly input to the relational database management system, retrieval results are returned. The same applies to the case of numerical ranges as in the item value history storage section 102. For example, the condition “ranging between 1000 yen and 2000 yen” is converted into

SQL3: SELECT name FROM wine WHERE ranging between 1000 yen and 2000 yen

The above description is about the principle of the present invention. This application presents several embodiments made by various modifications and extensions. The characteristic features of the respective embodiments to be described later will be briefly described below.

The first embodiment is a basic embodiment of a combination of a portion for registering history data and a portion of issuing a retrieval statement according to the above procedures in response to an instruction to generate a retrieval statement and obtaining a retrieval result.

The second embodiment is configured to manage a past purchase (or retrieval) history for each user, and when a given user of the database is replaced with another user, a history matching the new user is set to perform the same operation as in the first embodiment. In the first embodiment, there is no concept that “the system is operated differently for the respective users”. For 100 users, therefore, history data corresponding to the 100 users are simply added to form a retrieval statement. In the second embodiment, the 100 users are allowed to use different histories.

The third embodiment undergoes further development to automatically generate a proper retrieval statement at a proper timing and present the retrieval result to the user without even making him/her generate the instruction “generate some retrieval statement”. This operation is equivalent to, for example, a proposal like “It is almost lunchtime. Why don't you drop in at a nearby “soba” shop that serves tasty “soba”?” made by a meddlesome (?) secretary. More specifically, such operation can be realized by combining a time (timepiece) and a GPS (Global Positioning System) that has currently and rapidly been popularized for car navigation systems and the like. The timepiece detects “lunchtime”, whereas the GPS detects “nearby”. According to the third embodiment, if a condition rule for automatically generating the retrieval statement “retrieve and present a restaurant near the current position at lunch time” is input, the proposal “It is almost lunchtime. Why don't you drop in at a nearby “soba” shop that serves tasty “soba”?” can be made.

In the fourth embodiment, the recommendation count of each record in the past is recorded, and the priorities of database records to be currently recommended are changed by using the recommendation counts. If the records exhibit the same degree of preference, one of the records which exhibits a smaller past recommendation count is recommended with a higher priority. The concept “the recommendation count of a record” is easily misunderstood as the cumulative count of a value entry written in each item value history storage section, but they are different. “The recommendation count of a record” is the number of times that a given record, e.g., “Beaujolais red”, was actually recommended. On the other hand, “the cumulative count of the “red” item written in the item value history storage section” is the count that is cumulatively increased when, for example, the “Beaujolais red” record is presented to the user and the user selects it as an optimal record. Even when the “St.-Emilion red” record is presented to the user and the user selects it as an optimal record, “the cumulative count of the “red” item written in the item value history storage section” is incremented, but the recommendation count of the “Beaujolais red” is not incremented.

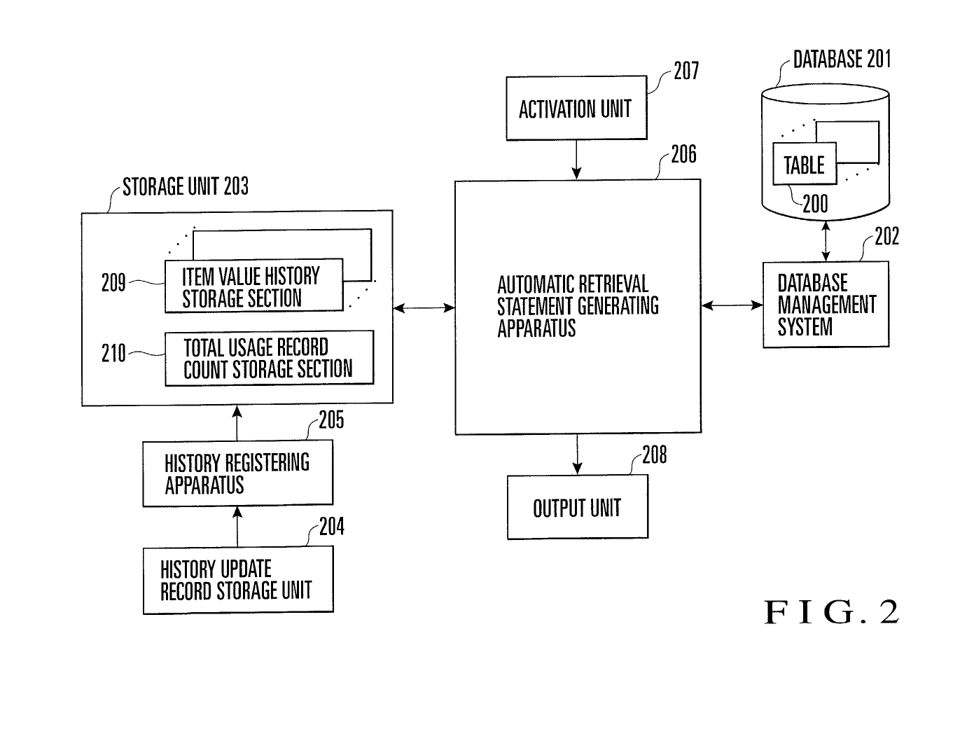

The basic arrangement and operation of the present invention will be described next. Referring to FIG. 2, the database retrieval system of the present invention is comprised of a database (relational database) 201 storing at least one table 200 consisting of at least one item in which retrieval target data is stored, a database management system 202 for retrieving data from the database 201 in response to a retrieval request that designates a retrieval statement and returning the retrieval result to the request source, a storage unit 203 having item value history storage sections 209, total usage record count storage section 210, and the like, a history update record storage unit 204 for storing history update records, a history registering apparatus 205 for receiving history update records stored in the history update record storage unit 204 and updating the item value history storage sections 209 and total usage record count storage section 210 in the storage unit 203, an automatic retrieval statement generating apparatus 206 for automatically generating a retrieval statement expected to retrieve information useful for a user on the basis of the data stored in the item value history storage sections 209 and total usage record count storage section 210 in the storage unit 203 and the like, and issuing it to the database management system 202, an activation unit 207 for activating the automatic retrieval statement generating apparatus 206, and an output unit 208 for outputting a database retrieval result to the user. The following is an outline of the function of the database retrieval system according to the present invention having the above arrangement.

The history update record storage unit 204 stores, as history update records, records, of the records in the table 200 in the database 201, in which the data of articles actually purchased by the user are recorded, and records, of the records retrieved from the table 200 in the database 201 and presented to the user, which were selected as optimal retrieval results by the user. In addition, all the records retrieved from the table 200 in the database 201 and presented to the user can be stored as history management records.

The item value history storage sections 209 are provided in one-to-one correspondence with the times of the table 200 in the database 201. When value sets that can be taken as the values of the corresponding items are divided into partial sets, each section 209 holds, for each partial set, item value history information constituted by an item value corresponding to the partial set, a conditional statement for determining whether a given item value is included in the partial set, and a cumulative count. The total usage record count storage section 210 holds the total number of history update records processed.

The history registering apparatus 205 receives a history update record from the history update record storage unit 204, and determines, for each item of the record, a specific partial set in the item in which the item value is included, according to the conditional statement in the item value history storage section 209 corresponding to the item. The history registering apparatus 205 then increments by one the cumulative count corresponding to the partial set in which the item value is included, and also increments the total number in the total usage record count storage section 210 by one. With this processing, of the items of the table 200, an item having an item value corresponding to the data associated with the article actually purchased by the user or the data associated with the article selected as an optimal retrieval result by the user gradually increases in cumulative count. This makes it possible to retain the characteristic features of the data of articles purchased by the user in the past or determined as optical retrieval results by the user as a history instead of retaining the data of the articles themselves which were actually purchased by the user or the data of the articles themselves which were selected as optimal retrieval results.

When the automatic retrieval statement generating apparatus 206 is activated by the activation unit 207 upon designating the type of a database from which data should be retrieved, the automatic retrieval statement generating apparatus 206 starts to execute a procedure for generating a retrieval statement for the table 200 in the database 201 by using the history stored in the storage unit 203 in the above manner, and presenting the retrieval result based on the retrieval statement to the user. First of all, the automatic retrieval statement generating apparatus 206 reads out the total number of usage records from the total usage record count storage section 210, and obtains a set of conditional statements in each item value history storage section 209 which has a cumulative count whose ratio to the total number of usage records is a predetermined value or more. An arbitrary conditional statement is extracted from the set of conditional statements in each item value history storage section 209, and all combinations of conditional statements from the sets in the respective item value history storage sections 209 are formed in a round-robin manner. The conditional statements in the combinations are merged by AND operation to generate a retrieval statement. The generated retrieval statement is then issued to the database management system 202, and the retrieval result is presented to the user through the output unit 208.

The embodiments of the present invention will be described in detail below.

(1) First Embodiment

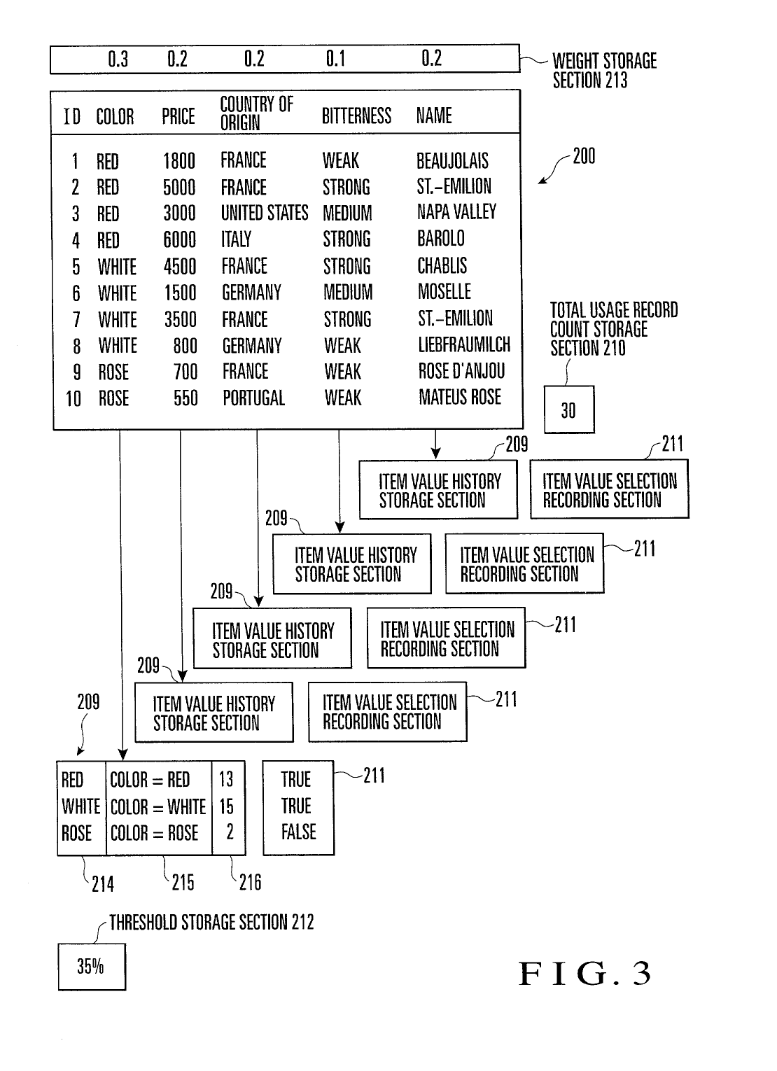

In a database retrieval system according to this embodiment, as shown in FIG. 3, a storage unit 203 includes an item value selection recording section 211 used to control an automatic retrieval statement generating apparatus 206, a threshold storage section 212, and a weight storage section 213 in addition to an item value history storage section 209 and a total usage record count storage section 210.

As described above, the total usage record count storage section 210 holds the total number of history update records processed. In the case shown in FIG. 3, the total number is “30”.

As described above, the item value history storage sections 209 are provided in one-to-one correspondence with the items of a table 200 in a database 201 in which a usage history is to be registered. FIG. 3 shows an example of the table 200 in the database 201, which includes five items, i.e., “color”, “price”, “country of origin”, “bitterness”, and “name”. Therefore, a total of five item value history storage sections 209 are provided for the table 200. Note that “ID” in the table 200 is a record identifier for uniquely identifying a record in the table. As described above, when value sets that can be taken as the values of the corresponding items are divided into partial sets, each item value history storage section 209 holds, for each partial set, item value history information consisting of an item value 214 corresponding to the partial set, a conditional statement 215 for determining whether a given item value is included in the partial set, and a cumulative count 216. For example, as the values of the “color” item, “red”, “white”, and “rose” exist. Therefore, the item value history storage section 209 corresponding to the “color” item includes the three item values 214 of “red”, “white”, and “rose”. As the conditional statements 215, the conditional statements “color =red”, “color=white”, and “color=rose” are set. As the cumulative counts 216, in the case shown in FIG. 3, “13” is recorded in correspondence with the item value of “red”; “15”, in correspondence with the item value of “white”; and “2”, in correspondence with the item value of “rose”. For example, this indicates that the 30 wines actually purchased by the user include 13 red wines, 15 white wines, and two rose wines. As in the item value history storage section 209 corresponding to the “color” item, in each of the item value history storage sections 209 corresponding to the “country of origin” item, “bitterness” item, and “name” item, an item value including the value appearing in the item itself, a conditional statement, and a cumulative count are set. In the item value history storage section 209 corresponding to the “price” item, a value appearing in the item itself is not set as an item value, but an item value such as “less than 1000 yen” or “between 1000 yen and 2000 yen”, a conditional statement (e.g., <1000 yen) for making the actual price of a wine fall in the corresponding numerical range, and a cumulative count are set.

In the weight storage section 213, weights of the respective items in the table 200, i.e., the respective item value history storage sections 209, are stored in advance. In the case shown in FIG. 3, the weight of the item value history storage section 209 corresponding to the “color” item is 0.3, the weights of the item value history storage sections 209 corresponding to “price”, “country of origin”, and the “name” items are 0.2, and the weight of the item value history storage section 209 corresponding to the “bitterness” item is 0.1.

The item value selection recording sections 211 are provided in one-to-one correspondence with the item value history storage sections 209. Each item value selection recording section 211 is used to temporarily record, for each item value of the corresponding item value history storage section 209, a determination result (true or false) indicating whether to use the corresponding item value when a retrieval statement is to be generated. The threshold storage section 212 is a portion in which a threshold used for this determination is stored in advance. Referring to FIG. 3, this threshold is “35%”. The value “10.5” obtained by multiplying the total number of usage record, “30”, stored in the total usage record count storage section 210 is the allowable lower limit value of the cumulative count of each item value history storage section 209. That is, “false” is set for an item value having a cumulative count less than this allowable lower limit value, and “true” is set for an item value having a cumulative count equal to or more than the allowable lower limit value.

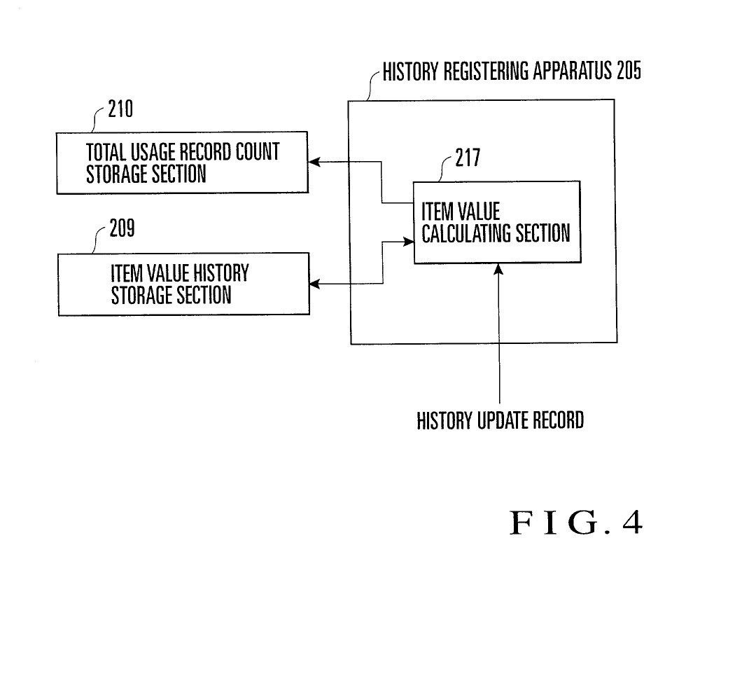

FIG. 4 shows an example of the arrangement of the history registering apparatus 205 in this embodiment. This history registering apparatus 205 is formed by an item value calculating section 217 for receiving a history update record from the history update record storage unit 204, extracting a value from each item of the received history update record, incrementing by one the cumulative count corresponding to an item value satisfying the conditional statement in the corresponding item value history storage section 209, and also incrementing the value of the total usage record count storage section 210 by one.

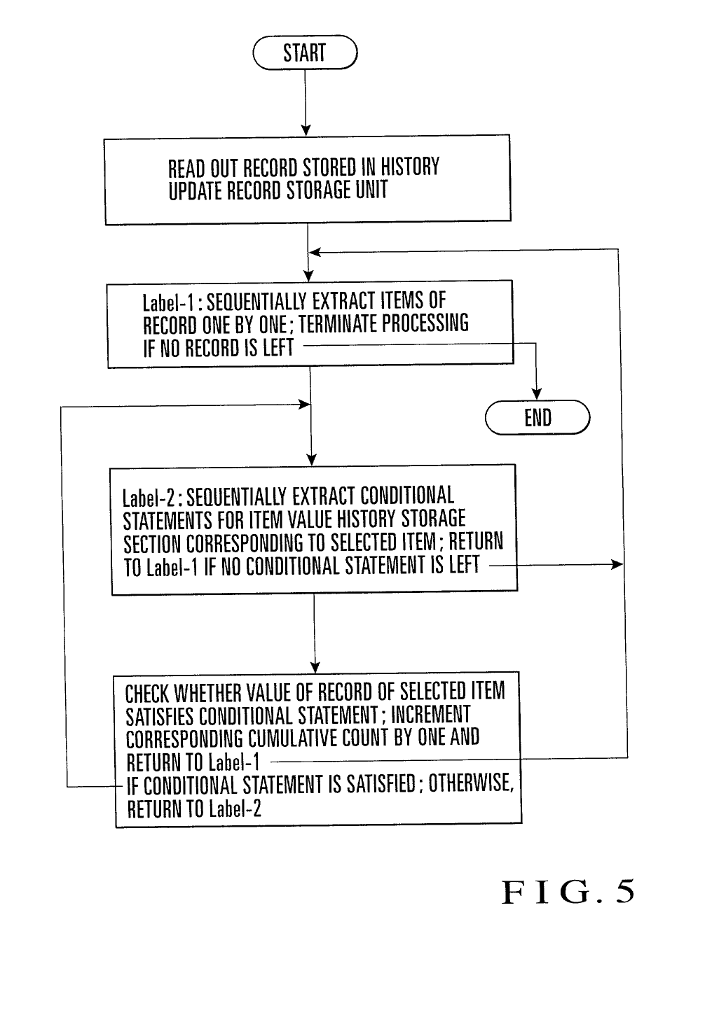

FIG. 5 shows processing performed by the item value calculating section 217 to update the item value history storage section 209. First of all, a history update record is read out from the history update record storage unit 204. The items of the record are then sequentially extracted one by one (Label-1). If all the items are processed, the processing is terminated. The conditional statement portions in the item value history storage section 209 corresponding to an extracted item are extracted one by one (Label-2). If all the conditional statements are referred to and no conditional statement is left, the flow returns to Label-1. Every time a conditional statement is extracted, it is checked whether the value of the record of the selected item satisfies the conditional statement. If it satisfies the conditional statement, the cumulative count corresponding to this conditional statement is incremented by one. The flow then returns to Label-1 to process the next item of the record. If this conditional statement is not satisfied, the flow returns to Label-2 to check another conditional statement in the same item.

The processing performed by the item value calculating section 217 will be described below, assuming that the history update record has “color” item=white, “price” item=4500 yen, “country of origin” item=France, “bitterness” item=strong, and “name” item=Chablis. Consider the item value history storage section 209 corresponding to the “color” item first. As shown in FIG. 3, the three conditional statements “color=red”, “color=white”, and “color=rose” exist in the conditional statement portions of the item value history storage section 209 corresponding to the “color” item. These conditional statements are extracted one by one to check whether the value of the “color” item of the history update record satisfies the extracted conditional statement. When it is checked whether the first conditional statement “color=red” is satisfied, since the value of the “color” item of the history update record indicates “white”, this conditional statement is not satisfied. It is therefore checked whether the next conditional statement is satisfied. Since the value of the history update record satisfies the next conditional statement “color=white”, the cumulative count corresponding to the conditional statement “color=white” is incremented by one. In the case shown in FIG. 3, since the cumulative count is 15, this value is set to 16. The processing for the “color” item is thus completed, and the flow returns to Label-1 to process the next item. Similar processing is performed for the “price”, “country of origin”, “bitterness”, and “name” items.

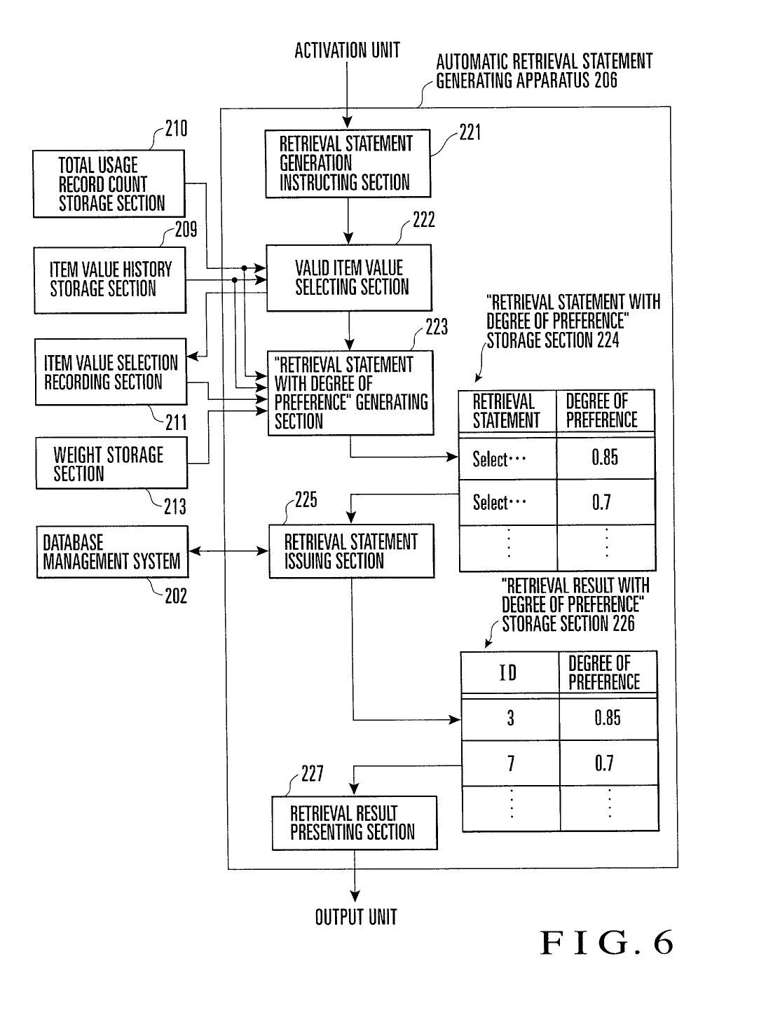

FIG. 6 shows an example of the arrangement of the automatic retrieval statement generating apparatus 206 in this embodiment. The automatic retrieval statement generating apparatus 206 in this case is comprised of a retrieval statement generation instructing section 221 for accepting, from an activation unit 207, an automatic generation instruction that designates the type of database from which data should be retrieved, a valid item value selecting section 222 for referring to the contents of the total usage record count storage section 210 and item value history storage sections 209 which correspond to the type of database from which data should be retrieved, upon reception of a notification indicating the acceptance of the automatic generation instruction from the retrieval statement generation instructing section 221, so as to select a valid item value in each item value history storage section 209 and set a true or false value in the corresponding item value selection recording section 211, a “retrieval statement with degree of preference” generating section 223 for generating retrieval statements with degrees of preference on the basis of the contents of the total usage record count storage section 210, item value history storage sections 209, item value selection recording sections 211, and weight storage section 213, a “retrieval statement with degree of preference” storage section 224 for storing the results obtained by the “retrieval statement with degree of preference” generating section 223, a retrieval statement issuing section 225 for issuing the retrieval statements, stored in the “retrieval statement with degree of preference” storage section 224, to the database management system 202 in decreasing order of degree of preference, and outputting the retrieval results and the corresponding degrees of preference in pairs, a “retrieval result with degree of preference” storage section 226 for storing the results from the retrieval statement issuing section 225, and a retrieval result presenting section 227 for extracting the retrieval results stored in the “retrieval result with degree of preference” storage section 226 in decreasing order of degree of preference and presenting them to the user through an output unit 208.

The retrieval statement generation instructing section 221 accepts an instruction to automatically generate retrieval statements when it is issued by the user through the activation unit 207. This instruction designates the type of database from which data should be retrieved. In this embodiment, the activation unit 207 is formed by an input unit such as a keyboard or a user terminal connected through a communication line. The retrieval statement generation instructing section 221 serves as a switch for accepting the instruction “generate some proper retrieval statements”. As this section, a flag for an activation instruction may be simply prepared by using a 1-bit memory, which may remain off and turn the flag on upon reception of the instruction. If a plurality of databases exist, a portion for designating the type of database from which data should be retrieved is also required.

Upon reception of a notification indicating the acceptance of an automatic generation instruction from the retrieval statement generation instructing section 221, the valid item value selecting section 222 compares, for each item value of each item value history storage section 209 corresponding to the type of database as a retrieval target, the corresponding cumulative count 216 with the value obtained by multiplying the value of the total usage record count storage section 210 by the value of the threshold storage section 212. If the cumulative count 216 is larger, the valid item value selecting section 222 stores a true value in the item value selection recording section 211, and stores a false value therein otherwise. The valid item value selecting section 222 performs this processing for all the item values of all the item value history storage sections 209.

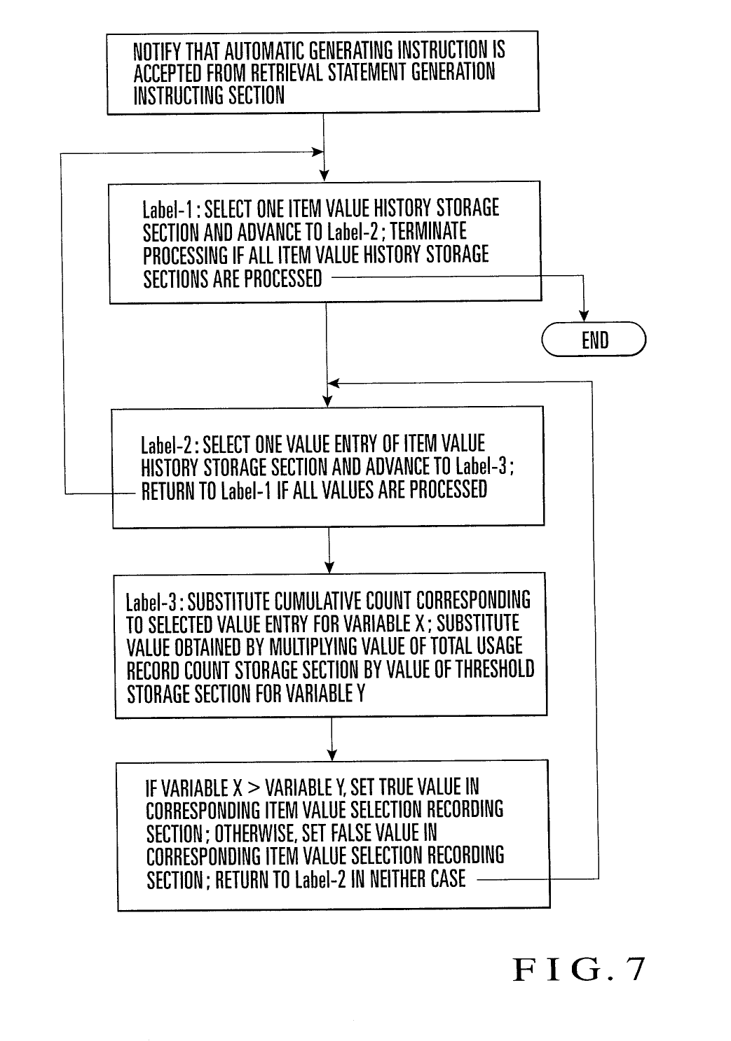

FIG. 7 shows an example of the processing performed by the valid item value selecting section 222. Upon reception of a notification indicating the acceptance of an automatic generation instruction from the retrieval statement generation instructing section 221, the valid item value selecting section 222 selects the item value history storage sections 209 one by one (Label-1). The flow then advances to Label-2. If all the item value history storage sections 209 are processed, the processing is terminated. In Label-2, one item value 214 is selected from the item value history storage section 209, and the flow advances to Label-3. If all the item values 214 are processed, the flow advances to Label-1. In Label-3, the valid item value selecting section 222 substitutes the value of the cumulative count 216 corresponding to the selected item value 214 for a variable X, and also substitutes the value obtained by multiplying the value of the total usage record count storage section 210 by the value of the threshold storage section 212 for a variable Y. The valid item value selecting section 222 then compares the variables X and Y with each other. If variable X>variable Y, a true value is set in the corresponding item value selection recording section 211. Otherwise, a false value is set in the corresponding item value selection recording section 211. In either case, the flow advances to Label-2.

A case where the “color” item is extracted in Label-1 will be described in detail below. In the case shown in FIG. 3, since the item values 214 of the “color” item include “red”, “white”, and “rose”, “red” is selected first. For the variable X, the cumulative count 216 of “red”, 13, is substituted. For the variable Y, 10.5 (30×0.35) is substituted, which is obtained by multiplying the value of the total usage record count storage section 210, 30, by the value of the threshold storage section 212, 35%. When X (13) is compared with Y (10.5), since X is larger, a true value is set in the corresponding item value selection recording section 211. Then, “white” is checked. With regard to “white”, since X=15 and Y=10.5, a true value is also set in the item value selection recording section 211 corresponding to “white”. With regard to “rose”, since X=2 and X (2)<Y (10.5), a false value is set in the item value selection recording section 211 corresponding to “rose”. As shown in FIG. 3, therefore, the values “true”, “true”, and “false” are stored in the item value selection recording section 211 corresponding to the “color” item.

The “retrieval statement with degree of preference” generating section 223 generates a set of conditional statements 215 corresponding to the true values in the item value selection recording section 211 for each item value history storage section 209, and extracts an arbitrary conditional statement from each set of conditional statements to form all combinations of conditional statements of the respective sets in the item value history storage sections 209 in a round-robin manner, thereby forming total conditional statements by merging the conditional statements in the combinations by AND operation. The “retrieval statement with degree of preference” generating section 223 then extracts weights corresponding to the item value history storage sections 209 in each respective combination from the weight storage section 213, and multiplies the weights by the values obtained by dividing the cumulative counts 216 corresponding to the item value history storage sections 209 by the values of the total usage record count storage section 210. The “retrieval statement with degree of preference” generating section 223 adds all the products and normalizes the sum, thereby calculating the degree of preference of the corresponding combination. The section 223 outputs the degrees of preference and total conditional statements in pairs.

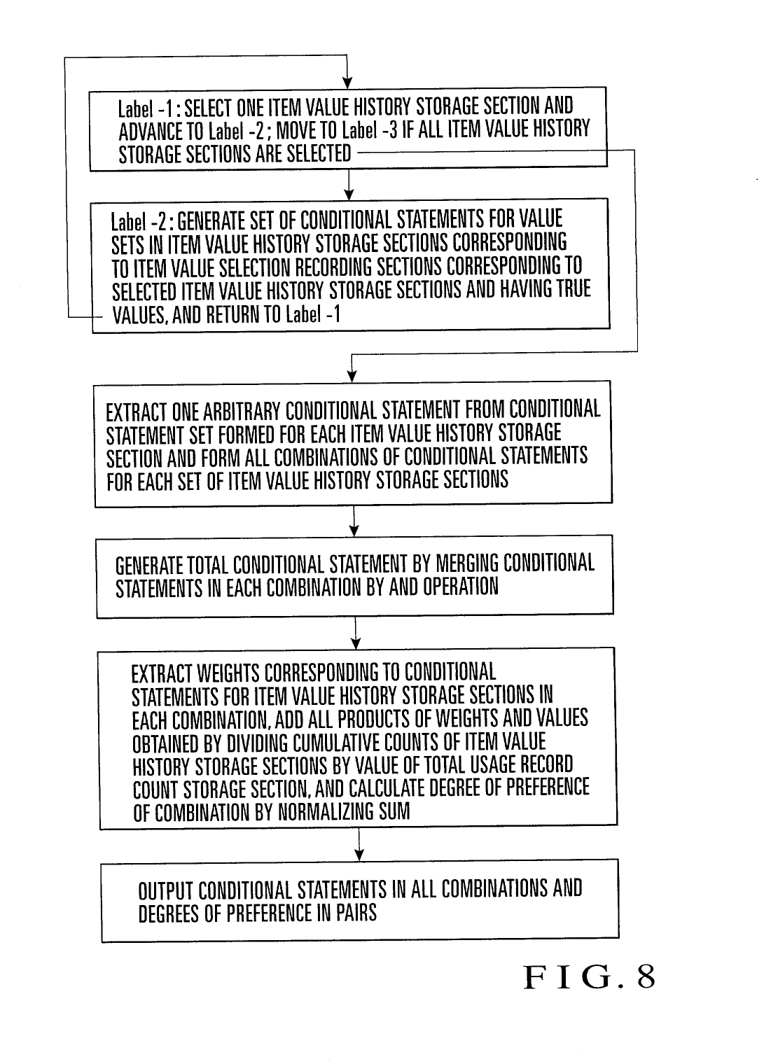

FIG. 8 shows an example of the processing performed by the “retrieval statement with degree of preference” generating section 223. First of all, the “retrieval statement with degree of preference” generating section 223 selects one item value history storage section 209 (Label-1). If the item value history storage section 209 to be selected exists, the flow advances to Label-2. For example, in the case shown in FIG. 3, the “color” item is selected, and the flow advances to Label-2. If all the item value history storage sections 209 are selected, the flow advances to Label-3. This indicates that when the item value history storage sections 209 are selected in the order of “color”, “price”, “country of origin”, “bitterness”, and “name”, and all the items are selected, the flow advances to Label-3.

In Label-2, the “retrieval statement with degree of preference” generating section 223 forms a set of conditional statements in the selected item value history storage section 209 which correspond to the true values in the item value selection recording section 211 corresponding to the selected item value history storage section 209. The flow the returns Label-1. In the case of the “color” item in FIG. 3, the true values in the item value selection recording section 211 are set for the two item values “red” and “white”. Therefore, the section 223 extracts these conditional statement portions to form a set. The set includes the following two elements:

(“color=red”, “color=white”)

Likewise, with regard to the “country of origin” item, a set including one element (“country of origin=France”) is formed. With regard to the “bitterness” item, a set including one element (“bitterness=strong”) is formed.

In Label-3, the “retrieval statement with degree of preference” generating section 223 extracts an arbitrary conditional statement from the set of conditional statements formed for each item value history storage section 209, and forms all combinations of conditional statements of the respective sets of the item value history storage sections 209. In this case, since there are three sets, 2×1×1=2. Therefore, the following two combinations can be obtained:

combination 1: “color=red” “country of origin=France” “bitterness=strong”

combination 2: “color=white” “country of origin=France” “bitterness=strong”

For the respective formed combinations, total conditional statements are formed by merging the conditional statements in the combinations by AND operation as follows:

total conditional statement 1: “color=red” AND “country of origin=France” AND “bitterness=strong”

total conditional statement 2: “color=white” AND “country of origin=France” AND “bitterness=strong”

These statements are converted into SQL statements by simple conversion processing:

SQL-1:

SELECT ID FROM wind WHERE “color=red” AND “country of origin=France” AND “bitterness=strong”

SQL2:

SELECT ID FROM wind WHERE “color=white” AND “country of origin=France” AND “bitterness=strong”

The “retrieval statement with degree of preference” generating section 223 then extracts weights corresponding to the conditional statements of the item value history storage sections 209 in each combination from the weight storage section 213, adds all the products of the weights and the values obtained by dividing the cumulative counts 216 of the item value history storage sections 209 by the value of the total usage record count storage section 210, and normalizes the resultant data, thereby calculating the degree of preference of the corresponding combination. In this case, if the values in the weight storage section 213 in FIG. 3 are to be used, the weight for the “color” item is 0.3, the weight for the “country of origin” item is 0.2, and the weight for the “bitterness” item is 0.1. The cumulative count of the conditional statement “color=red” is 13, the cumulative count of the conditional statement “country of origin=France” is 16, and the cumulative count of the conditional statement “bitterness=strong” is 15. Therefore,

$$\text{Degree of preference of total conditional}$$

$$\begin{matrix}\text{statement 1} = 0.3 \times ( 13 / 30 ) + 0.2 \times ( 16 / 30 ) + 0.1 \times \\ ( 15 / 30 ) / ( 0.3 + 0.2 + 0.1 ) \\ = 0.47\end{matrix}$$

$$\text{Degree of preference of total conditional}$$

$$\begin{matrix}\text{statement 2} = 0.3 \times ( 15 / 30 ) + 0.2 \times ( 16 / 30 ) + 0.1 \times \\ ( 15 / 30 ) / ( 0.3 + 0.2 + 0.1 ) \\ = 0.51\end{matrix}$$

The “retrieval statement with degree of preference” generating section 223 then outputs the conditional statements in all the combinations and the corresponding degrees of preference in pairs. Total conditional statement 1 and its degree of preference and total conditional statement 2 and its degree of preference are output as calculation results. These retrieval statements with degrees of preference are temporarily stored in the “retrieval statement with degree of preference” storage section 224.

The retrieval statement issuing section 225 rearranges the total retrieval statements in the “retrieval statement with degree of preference” storage section 224 in decreasing order of degree of preference, issues retrieval statements to the database management system 202 in decreasing order of degree of preference, and outputs the retrieval results and the corresponding degrees of preference in pairs. This operation will be described by taking the above case as an example. When retrieving operation is performed with respect to the table 200 in FIG. 3 by using SQL-1 given above, the record of St.-Emilion with ID=2 is retrieved. When retrieving operation is performed with respect to the table 200 in FIG. 3 by using SQL-2 given above, the records of Chablis with ID=5 and St.-Emilion with ID=7 are retrieved. These retrieval results are temporarily stored in the “retrieval result with degree of preference” storage section 226.

The retrieval result presenting section 227 extracts the retrieval results from the “retrieval result with degree of preference” storage section 226 in decreasing order of degree of preference, and presents them to the user through the output unit 208. In presenting the retrieval results to the user, a list of retrieval results may be displayed on the screen of the display unit of the output unit 208 or may be read out loud through the speaker of the output unit 208.

In the above case, all the retrieval results are presented. If, however, many records are retrieved, an interface may be configured such that after only upper 10 records are presented, the user is asked whether next 10 records are to be presented.

(2) Second Embodiment

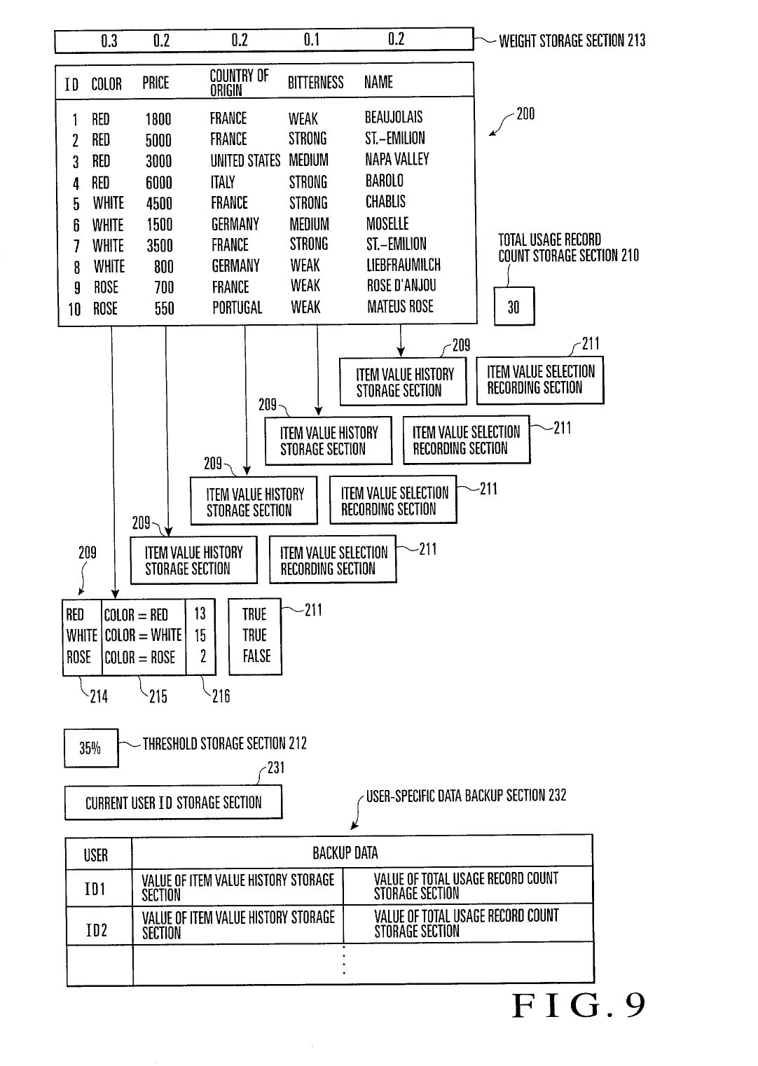

In this embodiment, different past histories are managed for the respective users, and when a given user of the database is replaced with another user, a history matching the new user is set to perform the same operation as in the first embodiment. In a database retrieval system according to this embodiment, as shown in FIG. 9, a storage unit 203 includes a current user ID storage section 231 and user-specific data backup section 232 in addition to an item value history storage section 209, total usage record count storage section 210, item value selection recording section 211, threshold storage section 212, and weight storage section 213 as in the first embodiment.

The current user ID storage section 231 is a portion for temporarily storing the ID of a user who currently uses the database retrieval system. The user-specific data backup section 232 is a portion for storing combinations of three values constituted by all user IDs, the values of the user-specific item value history storage sections 209, and the values of the user-specific total usage record count storage section 210.

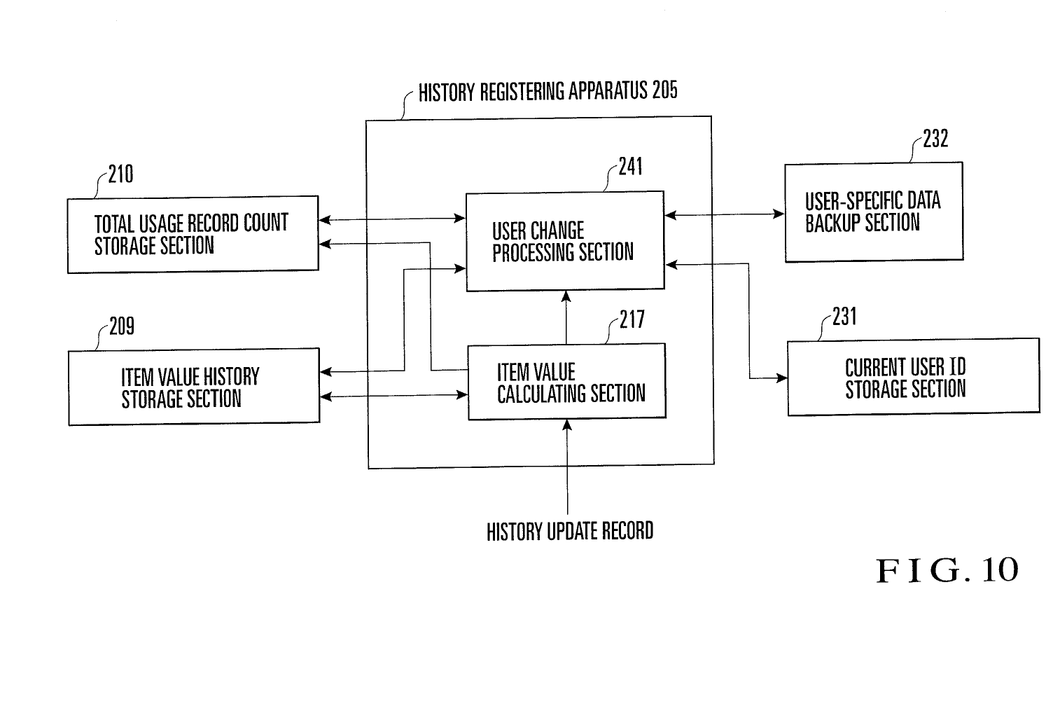

FIG. 10 shows an example of the arrangement of a history registering apparatus 205 in this embodiment. The history registering apparatus 205 in this case has a user change processing section 241 for interchanging data among the user-specific data backup section 232, total usage record count storage section 210, and item value history storage sections 209, in addition to an item value calculating section 217 similar to that in the history registering apparatus shown in FIG. 4 in the first embodiment.

A history update record stored in a history update record storage unit 204 has a user ID attached, which indicates a specific user for whom the record is used. Prior to the processing shown in FIG. 5, the item value calculating section 217 receives the attached user ID from the history update record storage unit 204 and outputs it to the user change processing section 241. The user change processing section 241 refers to the user ID stored in the current user ID storage section 231 to determine a specific user ID to which the contents currently stored in the item value history storage section 209 and total usage record count storage section 210 correspond. If the user ID differs from the user ID output from the item value calculating section 217, these contents are read out and retained in the user-specific data backup section 232. More specifically, if the contents currently stored in the item value history storage section 209 and total usage record count storage section 210 indicate user ID=ID1, the corresponding information is overwritten on the portion “user ID=ID1” in the user-specific data backup section 232. The value of the item value history storage section corresponding to the user ID output from the item value calculating section 217 in the user-specific data backup section 232 and the value of the total usage record count storage section 210 are read out and set in the item value history storage section 209 and total usage record count storage section 210. In addition, the user ID output from the item value calculating section 217 is set in the current user ID storage section 231. Thereafter, processing similar to that in the first embodiment is performed in the item value calculating section 217.

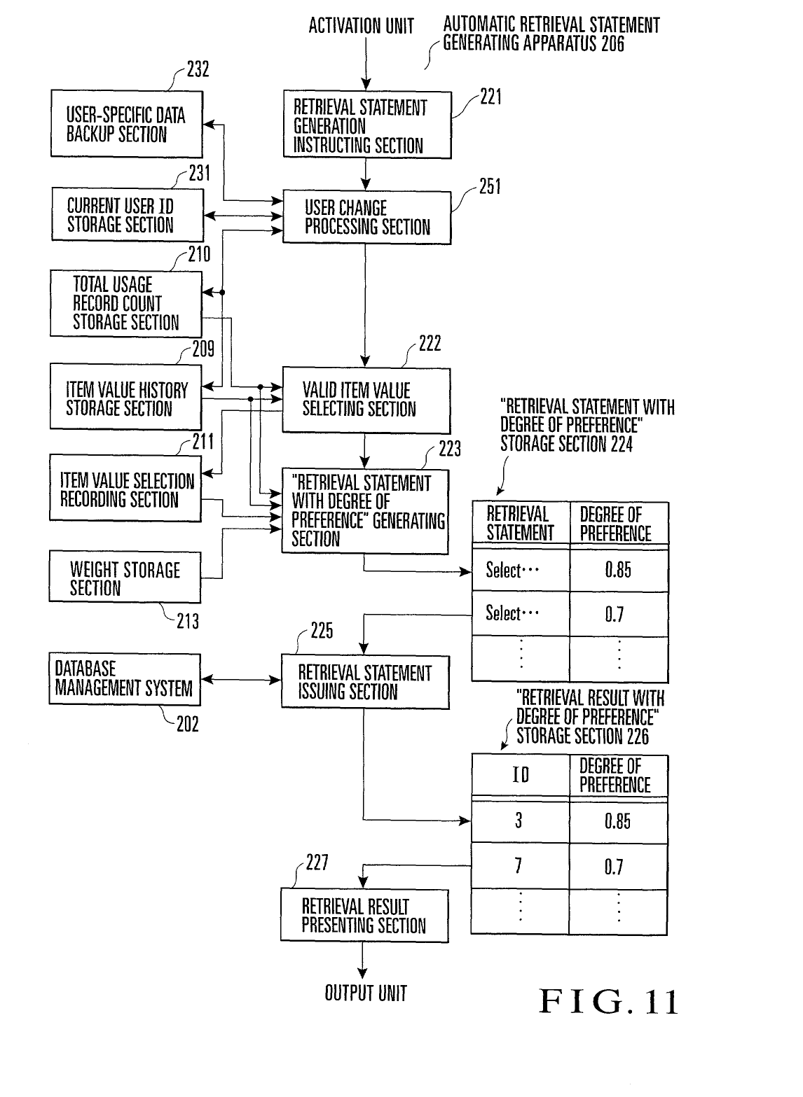

FIG. 11 shows an example of the arrangement of the automatic retrieval statement generating apparatus 206 in this embodiment. The automatic retrieval statement generating apparatus 206 in this case includes a user change processing section 251 between a retrieval statement generation instructing section 221 and valid item value selecting section 222 in addition to the constituent elements of the automatic retrieval statement generating apparatus 206 in the first embodiment shown in FIG. 6.

In this embodiment, when this system is activated by an activation unit 207, a user ID is notified from the activation unit 207. Upon reception of an automatic retrieval statement generating instruction that designates a user ID, the retrieval statement generation instructing section 221 notifies the user change processing section 251 of the user ID. The user change processing section 251 refers to the user ID stored in the current user ID storage section 231 to determine a specific ID to which the contents currently stored in the item value history storage section 209 and total usage record count storage section 210 correspond. If the user ID is different from the user ID notified from the activation unit 207, the user change processing section 251 reads out these contents and stores them in the user-specific data backup section 232. The history registering apparatus 205 reads out the value of the item value history storage section corresponding to the user ID notified from the activation unit 207 in the user-specific data backup section 232 and the value of the total usage record count storage section 210, and sets them in the item value history storage section 209 and total usage record count storage section 210. The history registering apparatus 205 also sets the user ID output from the item value calculating section 217 in the current user ID storage section 231. The valid item value selecting section 222 is then made to start processing. Subsequently, the same processing as in the first embodiment is performed in the valid item value selecting section 222, “retrieval statement with degree of preference” generating section 223, retrieval statement issuing section 225, and retrieval result presenting section 227.

(3) Third Embodiment

In the first and second embodiments, the user must explicitly give an instruction to automatically generate retrieval statements. This embodiment is configured to eliminate the necessity to make the user give any instruction and automatically generate proper retrieval statements and retrieve data to present them to the user at a proper timing.

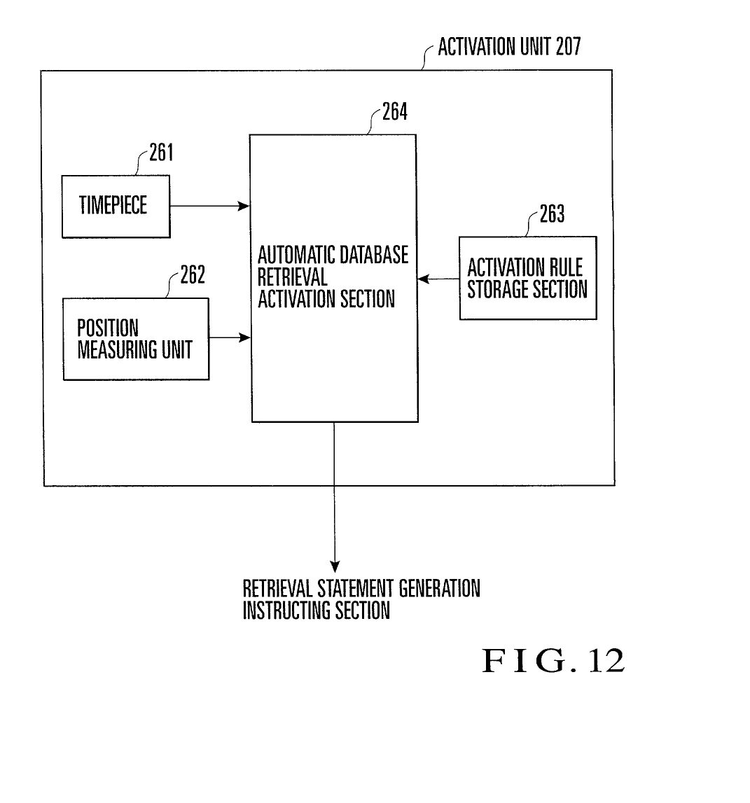

FIG. 12 shows an example of the arrangement of an activation unit 207 in this embodiment. The activation unit 207 in this embodiment is comprised of a timepiece 261, position measuring unit 262, activation rule storage section 263, and automatic database retrieval activation section 264.

The timepiece 261 measures the current time and notifies the automatic database retrieval activation section 264 of the current time at proper time intervals (e.g., one-minute intervals). The position measuring unit 262 is a unit for measuring the current position of the user. As a typical unit, a GPS mounted as a standard unit in a current car navigation system is available. The activation rule storage section 263 stores a condition rule for automatically activating data retrieval processing. Every time the current time is notified from the timepiece 261, the automatic database retrieval activation section 264 checks the validity of each condition rule in the activation rule storage section 263 by referring to the current time and the current position of the user measured by the position measuring unit 262. If the condition rule is satisfied, the automatic database retrieval activation section 264 issues a retrieval statement generating instruction to a retrieval statement generation instructing section 221 in the automatic retrieval statement generating apparatus 206. The arrangements and processing contents of the retrieval statement generation instructing section 221 and subsequent sections are the same as those in the first embodiment.

Each activation rule stored in the activation rule storage section 263 is formed by a condition portion that refers to time information and location information. If, for example, there is the following activation rule:

“retrieve data from the wine database at 7 o'clock in the evening”

then, a retrieval statement for retrieving wine records from the wine database is automatically generated and the wine records are presented to the user at 7 o'clock in the evening.

If the database retrieval system of this embodiment is incorporated in a car navigation system and mounted in a car and pieces of latitude and longitude information of various shops are stored in the car navigation system, the user can always know his/her current position through the position measuring unit 262. In this case, if there is the following activation rule:

“retrieve data from the wine database when I get near any large discount liquor shop”

then, a retrieval statement for retrieving wine records from the wine database is automatically generated and the wine records are presented to the user when he/she gets near any large discount liquor shop.

Activation rules are not limited to any specific format except that at least a condition portion and the type of database from which data should be retrieved must be written.

In this embodiment, the activation unit 207 shown in FIG. 12 is applied to the first embodiment. However, this unit can also be applied to the second embodiment. In this case, one user ID may be set in the automatic database retrieval activation section 264 or different user IDs may be set for the respective activation rules. In the latter case, an automatic generating instruction can be issued for each of a plurality of users.

(4) Fourth Embodiment

In a database retrieval system according to this embodiment, the recommendation count of each record in the past is recorded, and the priorities of database records to be currently recommended are changed in accordance with the recommendation counts in the past.

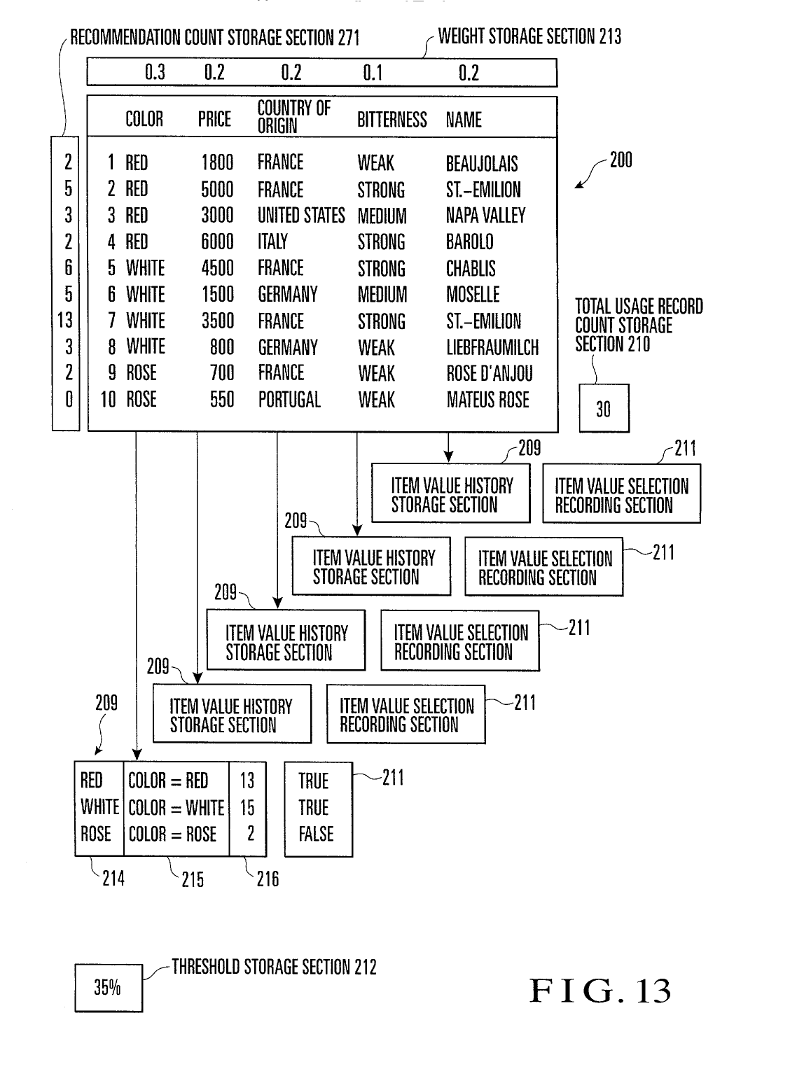

In the database retrieval system according to this embodiment, as shown in FIG. 13, a storage unit 203 includes a recommendation count storage section 271 in addition to an item value history storage section 209, total usage record count storage section 210, item value selection recording section 211, threshold storage section 212, and weight storage section 213 like those in the first embodiment.

The recommendation count storage section 271 is provided for each table 200 of a database 201 in which a usage history is to be registered, and serves to store the cumulative presentation count (recommendation count) of each record in the table 200 up to the current time. In the case shown in FIG. 13, for example, the value “5” is stored for St.-Emilion red with ID=2. This indicates that the wine with ID=2 was recommended to the user five times until now. Likewise, information indicating that Chablis white with ID=5 was recommended six times and St.-Emilion white was recommended 13 times is recorded.

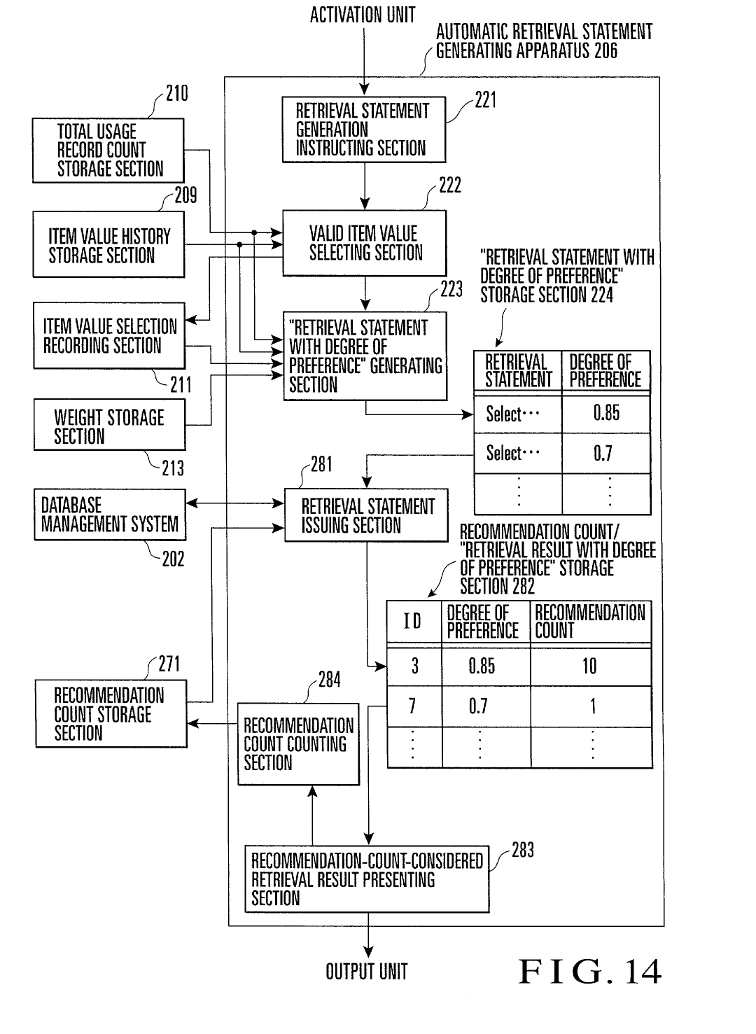

FIG. 14 shows an example of the arrangement of an automatic retrieval statement generating apparatus 206 in this embodiment. The automatic retrieval statement generating apparatus 206 in this case includes a retrieval statement issuing section 281, recommendation count/“retrieval result with degree of preference” storage section 282, recommendation-count-considered retrieval result presenting section 283, and recommendation count counting section 284, in addition to a retrieval statement generation instructing section 221, valid item value selecting section 222, “retrieval statement with degree of preference” generating section 223, and “retrieval statement with degree of preference” storage section 224 like those in the automatic retrieval statement generating apparatus 206 of the first embodiment shown in FIG. 6.

The retrieval statement issuing section 281 rearranges total retrieval statements in the “retrieval statement with degree of preference” storage section 224 in decreasing order of degree of preference, issues retrieval statements to a database management system 202 in decreasing order of degree of preference, and outputs the retrieval results and the recommendation counts stored in the recommendation count storage section 271 up to the current time in pairs in correspondence with the corresponding degrees of preference and the record IDs indicated by the retrieval results. The recommendation count/“retrieval result with degree of preference” storage section 282 is a portion for storing the record IDs as retrieval results, the corresponding degrees of preference, and the values in the recommendation count counting section 284 which correspond to the record IDs as combinations of three values.

The recommendation-count-considered retrieval result presenting section 283 extracts the retrieval results stored in the recommendation count/“retrieval result with degree of preference” storage section 282 in decreasing order of degree of preference and increasing order of recommendation count, and presents them to the user through an output unit 208. Every time the recommendation-count-considered retrieval result presenting section 283 presents (recommends) the content of a database record to the user, the recommendation count counting section 284 increments the cumulative presentation count in the recommendation count storage section 271 which corresponds to the record by one.

Assume that the following three retrieval results are output from the retrieval statement issuing section 281 and stored in the recommendation count/“retrieval result with degree of preference” storage section 282:

Chablis white with ID=5 degree of preference=0.51 recommendation count=6

St.-Emilion white with ID=7 degree of preference=0.51 recommendation count=13

St.-Emilion red with ID=2 degree of preference=0.47 recommendation count=5

If two records are equal in degree of preference, the recommendation-count-considered retrieval result presenting section 283 preferentially selects and presents one of the records which exhibits a smaller recommendation count. In the above case, of the two records whose degrees of preference are 0.51, Chablis white with ID=5 is preferentially presented because it exhibits a smaller recommendation count.

In this embodiment, when two records are equal in degree of preference, one that exhibits a smaller recommendation count is assigned a higher priority. If, however, a sales strategy like “recommend popular merchandise” or “sell merchandise that sells well” is employed, records exhibiting larger recommendation counts are preferentially presented. That is, recommendation counts can be considered in various manners, and hence the strategy “give higher priorities to records exhibiting smaller recommendation counts” is not limited as one and only strategy.

Note that this embodiment is an extension of the first embodiment, but can also be applied to the second embodiment. In this case, the user-specific data backup section 232 is configured to back up the values of the recommendation count storage section 271 in addition to the user IDs, the values of the item value history storage sections 209, and the value of the total usage record count storage section 210, and the values of the recommendation count storage section 271 are held and updated for the respective users. In addition, as the activation unit 207, the activation unit used in the third embodiment may be used.

As has been described above, according to the present invention, the following effects can be obtained.

According to the history registering apparatus, information about usage histories of an indefinite number of users or usage history of each user of a database can be retained with a relatively small storage capacity. This is because, this apparatus is configured to record the characteristic features of the data of articles purchased by users in the past or determined as optimal articles by the users as the cumulative counts of the respective items of records instead of directly retaining the data of the articles actually purchased by the users or data selected as optimal retrieval results by the users as histories.

According to the automatic database retrieval statement generating apparatus of the present invention, information useful to users can be obtained with a relatively small calculation amount on the basis of the past usage histories of an indefinite number of users or the usage history of each user of a database. The reason for this is that a retrieval range is narrowed down in consideration of a usage history in the process of generating a retrieval statement, and hence records useful to a user can be obtained by only issuing the generated retrieval statement to the database management system without requiring similarity calculation for each registered record as in the prior art.

As described above, according to the present invention, since the apparatus automatically generates a retrieval statement for a database and presents the retrieval result to a user without requiring the user to input any retrieval statement for selecting necessary information by himself/herself, the user can obtain information suited to the history information of the user, i.e., the preferences of the user without any consideration of the procedure. That is, an SQL retrieval statement for retrieving likelihood information by using a history can be automatically generated without requiring the user to generate any retrieval statement by himself/herself. Since retrieval statements can be automatically generated in this manner, for example, a “Push” type service can be provided, in which data is automatically retrieved from a database and presented as recommended records, at predetermined time intervals, to a driver who is driving a car. This also makes it possible to retrieve data from a database in place of a person, other than a driver, who is busy with some other work and does not want to do cumbersome operation of generating a retrieval statement for the database, without requiring him/her to designate any special conditions in detail.

A combination of the present invention and the technique disclosed in the reference given above makes it possible to obtain double effects. That is, the present invention generates an SQL retrieval statement first, and then the technique in the reference is used to automatically generate SQL retrieval statements similar to the SQL retrieval statement generated first, thereby obtaining a plurality of likelihood database SQL retrieval statements without making the user consider any of the above procedures.

What is claimed is:

1. A usage history registering apparatus comprising:
item value history storage units which are provided in one-to-once correspondence with items of a table in a relational database in which a usage history is to be registered, and hold item value history information for each of partial sets divided from value sets that can be taken as values of corresponding items, the item value history information being constituted by a conditional statement set for each partial set to determine a specific partial set to which a given item value belongs and a cumulative count for each partial set;
a total usage record count storage section for holding the total number of history update records processed; and
an item value counting section for receiving a history update record, determining, for each item of the input record, a specific partial set in the item to which a corresponding item value belongs, according to the conditional statement in the item value history information corresponding to the item, incrementing by one the cumulative count corresponding to the partial set to which the item value belongs, and also incrementing the total usage record count by one.

2. An apparatus according to claim 1, wherein
said apparatus further comprises a user-specific data backup section for retaining the item value history information and the total usage record count for each user ID, and
said item value counting section updates, on the basis of a history update record designating a use ID, item value history information corresponding to the user ID and the total usage record count.

3. An apparatus according to claim 1, wherein a record, of records in the table in the relational database, on which data of an article actually purchased by a user is recorded is used as the history update record.

4. An apparatus according to claim 1, wherein a record, of records retrieved from the table in the relational database and presented to a user, which is selected as an optical retrieval result by the user is used as the history update record.

5. A usage history registering apparatus comprising:
item value history storage units which are provided in one-to-once correspondence with items of a table in a relational database in which a usage history is to be registered, and hold item value history information for each of partial sets divided from value sets that can be taken as values of corresponding items, the item value history information being constituted by a conditional statement set for each partial set to determine a specific partial set to which a given item value belongs and a cumulative count for each partial set;
a total usage record count storage section for holding the total number of history update records processed;
an item value counting section for receiving a history update record, determining, for each item of the input record, a specific partial set in the item to which a corresponding item value belongs, according to the conditional statement in the item value history information corresponding to the item, incrementing by one the cumulative count corresponding to the partial set to which the item value belongs, and also incrementing the total usage record count by one;
a retrieval statement generation instructing section for accepting an automatic retrieval statement generating instruction;
a retrieval statement generating section for, when an automatic generating instruction is accepted by said automatic retrieval statement generation instruction section, obtaining, for each item, a set of conditional statements in item value history information having a cumulative count whose ratio to the total usage record count is not less than a predetermined value, extracting an arbitrary conditional statement from the set of conditional statements for each item, forming all combinations of conditional statements for the respective sets of items in a round-robin manner, and generating a retrieval statement by merging the conditional statements in the combinations by AND operation;
a retrieval statement issuing section for issuing the retrieval statement generated by said retrieval statement generating section to a database management system for the relational database; and
a retrieval statement result presenting section for presenting the retrieval result to a user.

6. An apparatus according to claim 5, wherein
said retrieval statement generating section adds all products of weights set in advance for the respective items in each combination and values obtained by dividing cumulative counts of the respective items by the total usage record count, calculates a degree of preference of the combination by normalizing the sum, and outputs the degrees of preference and total retrieval statements in pairs,
said retrieval statement issuing section issues the total retrieval statement generated by said retrieval statement generating section to the database management system for the relational database and outputs retrieval results and corresponding degrees of preference in pairs, and
said retrieval result presenting section presents the retrieval results to the user in decreasing order of degree of preference.

7. An apparatus according to claim 6, wherein
said apparatus further comprises
a recommendation count storage section for storing a presentation count of each record of the table in the relational database up to the current time, and
a recommendation count counting section for, every time said retrieval result presenting section presents a content of a record in the database to the user, incrementing a presentation count of said recommendation count storage section corresponding to the record by one, and
said retrieval result presenting section is configured to control priorities of a plurality of records having the same degree of preference in presentation on the basis of presentation counts of the records up to the current time.

8. An apparatus according to claim 5, further comprising an activation unit for receiving an automatic retrieval statement generating instruction from the user and outputting the instruction to said retrieval statement generation instructing section.

9. An apparatus according to claim 5, further comprising:
a timepiece for measuring the current time;
a position measuring unit for measuring a current position of the user;
an activation rule storage section storing a condition rule describing a condition for automatically activating database retrieval processing; and
an automatic database retrieval activation section for checking validity of the condition rule in said activation rule storage section by referring values of said timepiece and said position measuring unit at predetermined time intervals, and if the condition rule is satisfied, outputting an automatic generating instruction to said retrieval statement generation instructing section.

10. A usage history registering apparatus comprising:
item value history storage units which are provided in one-to-once correspondence with items of a table in a relational database in which a usage history is to be registered, and hold item value history information for each of partial sets divided from value sets that can be taken as values of corresponding items, the item value history information being constituted by a conditional statement set for each partial set to determine a specific partial set to which a given item value belongs and a cumulative count for each partial set;
a total usage record count storage section for holding the total number of history update records processed;
an item value counting section for receiving a history update record, determining, for each item of the input record, a specific partial set in the item to which a corresponding item value belongs, according to the conditional statement in the item value history information corresponding to the item, incrementing by one the cumulative count corresponding to the partial set to which the item value belongs, and also incrementing the total usage record count by one;
a retrieval statement generation instructing section for accepting an automatic retrieval statement generating instruction designating a user ID;
a current user ID storage section for storing a user ID of a current user;
a user change processing section for saving stored contents of said item value history storage sections and said total usage record storage section into said user-specific data backup section when said retrieval statement generation instruction section accepts an automatic generating instruction and a user ID designated by the automatic generating instruction differs from a user ID stored in said current user ID storage section, restoring item value history information corresponding to a user ID designated by the automatic generating instruction stored in said user-specific data backup section and a total usage record count in said item value history storage section and said total usage record count storage section, and storing the user ID designated by the automatic generating instruction in said current user ID storage section;
a retrieval statement generating section for obtaining, for each item, a set of conditional statements in item value history information in said item value history storage section having a cumulative count whose ratio to the total usage record count is not less than a predetermined value following the processing by said user change processing section, extracting an arbitrary conditional statement from a set of conditional statements for each item, forming all combinations of conditional statements in the respective sets of items in a round-robin manner, and generating a retrieval statement by merging the conditional statements in each combination by AND operation;
a retrieval statement issuing section for issuing the retrieval statement generated by said retrieval statement generating section to a database management system for the relational database and obtaining a retrieval result; and
a retrieval result presenting section for presenting the retrieval result to a user.

11. An apparatus according to claim 10, wherein
said retrieval statement generating section adds all products of weights set in advance for the respective items in each combination and values obtained by dividing cumulative counts of said item value history storage sections by a value of said total usage record count storage section, calculates a degree of preference of the combination by normalizing the sum, and outputs the degrees of preference and total retrieval statements in pairs,
said retrieval statement issuing section issues the total retrieval statement generated by said “retrieval statement with degree of preference” generating section to the database management system for the relational database and outputs retrieval results and corresponding degrees of preference in pairs, and
said retrieval result presenting section presents the retrieval results to the user in decreasing order of degree of preference.

12. An automatic database retrieval statement generating apparatus comprising:
item value history storage units which are provided in one-to-once correspondence with items of a table in a relational database in which a usage history is to be registered, and hold item value history information for each of partial sets divided from value sets that can be taken as values of corresponding items, the item value history information being constituted by a conditional statement set for each partial set to determine a specific partial set to which a given item value belongs and a cumulative count for each partial set;
a total usage record count storage section for holding the total number of history update records processed;
a recommendation count storage section for storing a presentation count of each record of the table in the relational database up to the current time;
a user-specific data backup section for retaining, for each user ID, the item value history information, the total usage record count, and the presentation count;
an item value counting section for receiving a history update record designating a user ID and updating item value history information corresponding to the user ID and the total usage record count, said item value counting section determining, for each item of the input record, a specific partial set in the item to which a corresponding item value belongs, according to the conditional statement in the item value history information corresponding to the item, incrementing by one the cumulative count corresponding to the partial set to which the item value belongs, and also incrementing the total usage record count by one;
a retrieval statement generation instructing section for accepting an automatic retrieval statement generating instruction designating a user ID;
a current user ID storage section for storing a user ID of a current user;
a user change processing section for saving stored contents of said item value history storage sections, said total usage record storage section, and said recommendation count storage section into said user-specific data backup section when said retrieval statement generation instruction section accepts an automatic generating instruction and a user ID designated by the automatic generating instruction differs from a user ID stored in said current user ID storage section, restoring item value history information corresponding to a user ID designated by the automatic generating instruction stored in said user-specific data backup section, a total usage record count, and a presentation count in said item value history storage section, said total usage record count storage section, and said recommendation count storage section, and storing the user ID designated by the automatic generating instruction in said current user ID storage section;
a “retrieval statement with degree of preference” generating section for obtaining, for each item, a set of conditional statements in item value history information in said item value history storage section having a cumulative count whose ratio to the total usage record count is not less than a predetermined value following the processing by said user change processing section, extracting an arbitrary conditional statement from a set of conditional statements for each item, forming all combinations of conditional statements in the respective sets of items in a round-robin manner, generating a retrieval statement by merging the conditional statements in each combination by AND operation, adding all products of weights set in advance for the respective items in each combination and values obtained by dividing cumulative counts of said item value history storage sections by a value of said total usage record count storage section, calculating a degree of preference of the combination by normalizing the sum, and outputting the degrees of preference and total retrieval statements in pairs;
a retrieval statement issuing section for issuing the total retrieval statement generated by said “retrieval statement with degree of preference” generating section to the database management system for the relational database and outputting retrieval results and corresponding degrees of preference in pairs;
a retrieval result presenting section for presenting the retrieval results to the user in decreasing order of degree of preference; and
a recommendation count counting section for, every time said retrieval result presenting section presents a content of a record in the database to the user, incrementing a presentation count of said recommendation count storage section corresponding to the record by one,
wherein said retrieval result presenting section is configured to control priorities of a plurality of records having the same degree of preference in presentation on the basis of presentation counts of the records for the user up to the current time.

13. An apparatus according to claims 10, further comprising an activation unit for receiving an automatic retrieval statement generating instruction from the user and outputting the instruction to said retrieval statement generation instructing section.

14. An apparatus according to claim 12, further comprising an activation unit for receiving an automatic retrieval statement generating instruction from the user and outputting the instruction to said retrieval statement generation instructing section.

15. An apparatus according to claim 10, further comprising:
a timepiece for measuring the current time;
a position measuring unit for measuring a current position of the user;
an activation rule storage section storing a condition rule describing a condition for automatically activating database retrieval processing; and
an automatic database retrieval activation section for checking validity of the condition rule in said activation rule storage section by referring values of said timepiece and said position measuring unit at predetermined time intervals, and if the condition rule is satisfied, outputting an automatic generating instruction to said retrieval statement generation instructing section.

16. An apparatus according to claim 12, further comprising:
a timepiece for measuring the current time;
a position measuring unit for measuring a current position of the user;
an activation rule storage section storing a condition rule describing a condition for automatically activating database retrieval processing; and
an automatic database retrieval activation section for checking validity of the condition rule in said activation rule storage section by referring values of said timepiece and said position measuring unit at predetermined time intervals, and if the condition rule is satisfied, outputting an automatic generating instruction to said retrieval statement generation instructing section.
